(19) United States
(12) Patent Application Publication
(10) Pub. No.: US 2026/0228943 A1
(43) Pub. Date: Aug. 6, 2026

(54) IMAGE PROCESSING METHOD AND APPARATUS, DEVICE, COMPUTER READABLE STORAGE MEDIUM, AND PRODUCT

(71) Applicant: Beijing Zitiao Network Technology Co., Ltd., Haidian District, Beijing (CN)

(72) Inventors: Yue Liu, Beijing (CN); Bo Liu, Beijing (CN); Xinghua Zhang, Beijing (CN); Nan Xu, Beijing (CN)

(21) Appl. No.: 19/116,590

(22) PCT Filed: Sep. 14, 2023
(86) PCT No.: PCT/CN2023/118906

§ 371 Date: Mar. 28, 2025

(30) Foreign Application Priority Data
Sep. 30, 2022 (CN) 202211218295.0

(51) Int. Cl. G06T 11/60; G06T 11/10

(52) U.S. Cl. CPC G06T 11/60; G06T 11/10; G06T 2200/24; G06T 2210/62

(57) ABSTRACT

The embodiment of the application provides a method of image processing, an apparatus, an electronic device, a computer readable storage medium, a computer program product and a computer program, and the method includes: in response to a region selection operation triggered by a user for an image to be processed, determining a region to be processed in the image to be processed; generating a target mask based on the region to be processed, and generating a sampling region according to the target mask and the image to be processed; in response to a first editing request triggered by the user, performing a first editing operation on the sampling region and determining the edited target region as a target image.

### CROSS-REFERENCE TO RELATED APPLICATIONS

This application claims priority to Chinese Patent Application No. 202211218295.0, entitled “IMAGE PROCESSING METHOD AND APPARATUS, DEVICE, COMPUTER READABLE STORAGE MEDIUM, AND PRODUCT” filed on Sep. 30, 2022, which is incorporated herein by reference in its entirety.

### FIELD

The embodiment of the present application relates to the technical field of image processing, in particular to an image processing method and an apparatus, an electronic device, a computer readable storage medium, a computer program product and a computer program.

### BACKGROUND

With the improvement of hardware performance of the terminal device and the continuous improvement of the artificial intelligence technology, more and more applications (APP) have run on the terminal device. For example, in order to facilitate the user to edit the image, the image processing application has gradually entered the life of the user.

During image processing, a user may have a need to extract a certain region in the currently processed image. The accuracy of the extraction results obtained by the existing region extraction operations is often not high, which may not meet the actual needs of users, resulting in poor user experience.

### SUMMARY

The embodiment of the present application provides a method of image processing and an apparatus, an electronic device, a computer readable storage medium, a computer program product and a computer program.

According to a first aspect, an embodiment of the present disclosure provides a method of image processing, including:
in response to a region selection operation triggered by a user for an image to be processed, determining a region to be processed in the image to be processed;
generating a target mask based on the region to be processed, and generating a sampling region according to the target mask and the image to be processed;
in response to a first editing request triggered by the user, performing a first editing operation on the sampling region and determining the edited target region as a target image.

According to a second aspect, an embodiment of the present disclosure provides an n apparatus for image processing, including:
a selecting module configured to, in response to a region selection operation triggered by a user for an image to be processed, determine a region to be processed in the image to be processed;
a generation module configured to generate a target mask based on the region to be processed, and generate a sampling region according to the target mask and the image to be processed; and
an editing module configured to in response to a first editing request triggered by the user, perform a first editing operation on the sampling region and determine the edited target region as a target image.

According to a third aspect, an embodiment of the present disclosure provides an electronic device, including a processor and a memory;
the memory storing computer executable instructions;
the processor executing the computer-executable instructions stored in the memory, to cause the processor to perform the method of image processing according to the first aspect and various possible designs of the first aspect.

According to a fourth aspect, an embodiment of the present disclosure provides a computer-readable storage medium, wherein the computer-readable storage medium stores computer-executable instructions, and the computer-executable instructions, when executed by the processor, implement the method of image processing according to the first aspect and the possible designs of the first aspect.

According to a fifth aspect, an embodiment of the present disclosure provides a computer program product, including a computer program, where the computer program, when executed by a processor, implements the image processing method according to the first aspect and various possible designs of the first aspect.

According to a sixth aspect, an embodiment of the present disclosure provides a computer program product comprising a computer program, wherein the computer program, when executed by a processor, implements the method of image processing according to the first aspect and various possible designs of the first aspect.

According to a method of image processing, an apparatus, a computer readable storage medium, a computer program product and a computer program provided by the embodiment, after the region to be processed in the image to be processed is determined according to the region selection operation triggered by the user, the target mask is generated based on the region to be processed, and the sampling region is generated according to the target mask. In response to a first editing request triggered by the user, a first editing operation is performed on the sampling region to obtain a target image.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is a schematic flowchart of a method of image processing according to an embodiment of the present disclosure.

FIG. 2 is a schematic diagram of a target mask provided by an embodiment of the present disclosure.

FIG. 3 is a schematic diagram of generating a sampling region according to an embodiment of the present disclosure.

FIG. 4 is a schematic diagram of editing a sampling region according to an embodiment of the present disclosure.

FIG. 5 is a schematic flowchart of a method of image processing according to still another embodiment of the present disclosure.

FIG. 6 is a schematic structural diagram of an apparatus for image processing according to an embodiment of the present disclosure.

FIG. 7 is a schematic structural diagram of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. All other embodiments obtained by those skilled in the art based on the embodiments of the present disclosure without creative efforts shall fall within the scope of the present disclosure.

The present disclosure provides a method of image processing, an apparatus, an electronic device, a computer-readable storage medium, a computer program product, and a computer program.

It should be noted that the present disclosure provides a method of image processing, an apparatus, an electronic device, a computer-readable storage medium, a computer program product, and a computer program, which may be applied to various image processing scenarios, so that accuracy of an region extraction operation may be improved, a generated target image may be more suitable fora personalized requirement of a user, and then a subsequent image processing operation may be performed based on the image to obtain a better processing effect and improve user experience.

In the existing method of image processing, when region extraction needs to be performed, the region selected by the user is generally directly used as the finally extracted region, so as to subsequently perform image restoration operation according to the region, or image matting on the region. However, the region extracted by using the foregoing method is often not high in accuracy, and may not meet personalized needs of users.

In order to improve the accuracy of region extraction, the region to be processed in the image to be processed may be determined in response to the region selection operation triggered by the user for the image to be processed. A target mask is generated based on the region to be processed, and a sampling region is generated according to the target mask and the image to be processed. Optionally, in the process of generating the target mask, the user may adjust the target mask according to actual requirements, so that the sampling region generated subsequently according to the target mask is more accurate. Further, the user may also trigger the first editing request for the sampling region to perform the first editing operation on the sampling region according to the first editing request, and determine the edited target region as the target image. Through the two editing operations, the accuracy of the generated target image may be effectively improved, and the user experience is improved.

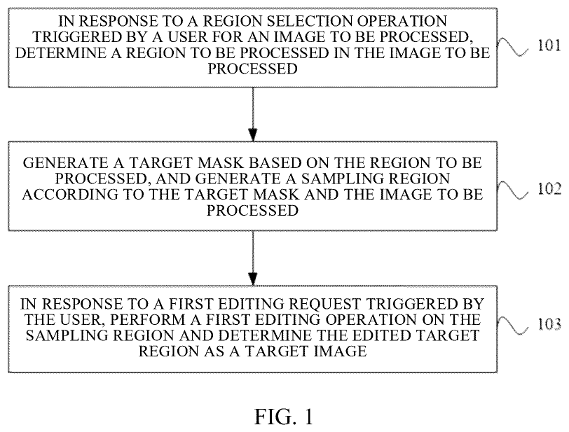

FIG. 1 is a schematic flowchart of a method for image processing according to an embodiment of the present disclosure.

Step 101: in response to a region selection operation triggered by a user for an image to be processed, determine a region to be processed in the image to be processed The execution body of this embodiment is an apparatus for image processing, which may be coupled to the terminal device, so that an editing operation on the sampling region may be performed in response to a trigger operation by the user on the terminal device. Optionally, the apparatus for image processing may alternatively be coupled to a server, and the server may be communicatively connected to the terminal device, so as to obtain an instruction triggered by the user on the terminal device to perform an editing operation on a sampling region.

In this embodiment, during the editing process of the image to be processed, the user may determine the sampling region according to actual requirements, and extract the sampling region. Therefore, the image to be processed may be subsequently restored based on the sampling region, or the sampling region may be stored as a matted image.

To extract the sampling region, the user may first trigger a region selection operation for the image to be processed. Optionally, the region selection operation may be triggered by triggering a predetermined selection control, or the region selection operation may be triggered by performing a predetermined trigger operation on the image to be processed, for example, the region selection operation may be triggered by operations such as long-press, double-click, smearing, and the like, which is not limited in the present disclosure.

Correspondingly, in response to the region selection operation triggered by the user for the image to be processed, the region to be processed in the image to be processed may be determined based on the region selection operation.

Step 102: generate a target mask based on the region to be processed, and generating a sampling region according to the target mask and the image to be processed.

In this embodiment, after determining the region to be processed in the image to be processed, the target mask may be generated based on the region to be processed. The target mask includes a sampling region and a non-sampling region. The sampling region matches the region to be processed. In the target mask, the pixel values of the sampling region are different from the pixel values of the non-sampling region. Optionally, a pixel value of the sampling region may be 1, and a pixel value of the non-sampling region may be 0.

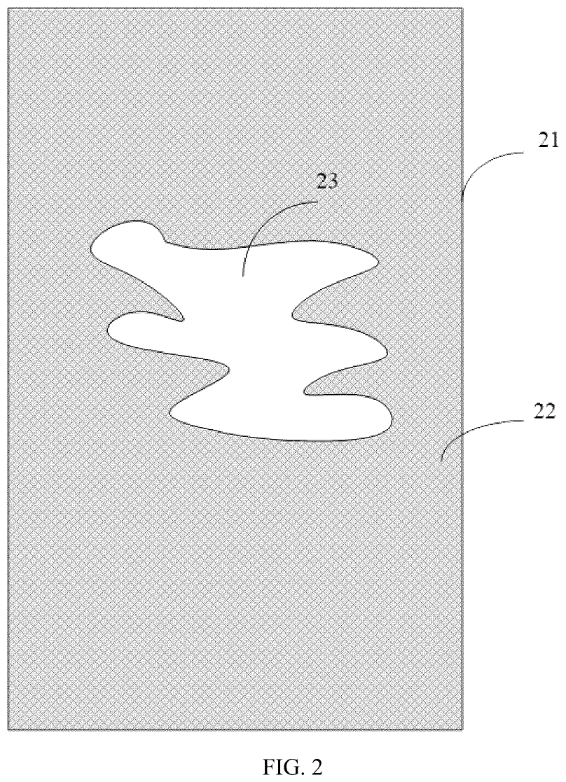

FIG. 2 is a schematic diagram of a target mask according to an embodiment of the present disclosure.

Optionally, in the target mask generation process, the user may further trigger a predetermined operation according to the actual demand, where the predetermined operation includes, but is not limited to, a predetermined operation on the target mask, and a predetermined operation on the region to be processed. For example, the user may perform an editing operation on the mask according to an actual requirement, so that the target mask is more suitable for the actual requirement of the user. Alternatively, the user may adjust a coverage region and a coverage location of the region to be processed that is generated, so that the region to be processed is more consistent with an actual requirement of the user, and then a target mask that is more suitable for an actual requirement may be generated. Therefore, the target mask may be generated based on the region to be processed and a predetermined operation triggered by the user.

After the target mask is obtained, the target mask may be fused with the image to be processed to obtain a sampling region matching the region to be processed.

Step 103: in response to a first editing request triggered by the user, perform a first editing operation on the sampling region and determine the edited target region as a target image

In the present embodiment, the region to be processed may be manually painted or automatically generated by the user according to actual requirements, and therefore, the region to be processed may often be poor in precision or not enough to fit a personalized requirement of the user. Therefore, in order to optimize the image processing effect, after obtaining the sampling region, the user may also perform editing operations on the sampling region according to actual requirements.

Optionally, the first editing request triggered by the user may be obtained. The first editing request may be generated after the user triggers the predetermined editing control, or may be generated in response to a predetermined operation triggered by the user for the sampling region, which is not limited in the present disclosure.

The first editing request may further include editing content, and therefore, after obtaining the first editing request triggered by the user, the first editing operation may be performed on the sampling region according to the first editing request to obtain an edited target region, and then the target image may be obtained based on the edited target region. Optionally, an image segmentation operation may be performed on the image to be processed according to the edited target region to obtain the target image.

According to the method of image processing provided in this embodiment, after the region to be processed in the image to be processed is determined in response to the region selection operation triggered by the user, a target mask is generated based on the region to be processed, and a sampling region is generated based on the target mask. In response to a first editing request triggered by the user, a first editing operation is performed on the sampling region and determining the edited target region as a target image. Therefore, the accuracy of the region extraction operation may be improved. Therefore, the generated target image may be more suitable for the personalized requirement of the user, and then the subsequent image processing operation may be performed based on the image to obtain a better processing effect and improve the user experience.

Further, on the basis of any one of the above embodiments, step 101 includes:
in response to a painting operation triggered by the user on the image to be processed, determining a painting region corresponding to the painting operation, and determining the painting region as the region to be processed;
or, in response to an object recognition request triggered by the user for the image to be processed, performing a recognition operation on at least one predetermined object in the image to be processed, and in response to a selection operation by the user on the at least one predetermined object, determining a region in which the predetermined object selected by the user is located as the region to be processed;
or, in response to the region selection operation triggered by the user for the image to be processed, displaying at least one shaped template that is predetermined and determining a target shaped template selected by the user, and in response to a moving operation by the user on the target shaped template, determining a region in which the moved target shaped template is located as the region to be processed.

In this embodiment, the region to be processed may be specifically generated by the user according to actual needs. Optionally, the user may trigger the painting operation on the image to be processed. The shape and size of brush and other information corresponding to the painting operation may be set by the user according to actual needs, which is not limited in the present disclosure. In response to the painting operation, a painting region corresponding to the painting operation may be determined, and the painting region may be determined as the region to be processed.

Optionally, the region to be processed may be specifically obtained by automatically identifying the image to be processed in response to a region selection operation triggered by a user. Optionally, after obtaining the image to be processed, the user may generate the object recognition request by using a predetermined trigger operation. For example, the user may implement generation of the object recognition request by triggering a predetermined recognition control. In response to the object recognition request triggered by the user for the image to be processed, at least one predetermined object in the image to be processed is recognized. The predetermined object includes, but is not limited to, content such as a person, an animal and a designated pattern in the image to be processed. Any image recognition method may be used to implement the recognition operation on the predetermined object, which is not limited in the present disclosure. After the at least one predetermined object is obtained, the region where the predetermined object selected by the user is located is determined as the region to be processed in response to the selection operation triggered by the user on the at least one predetermined object.

Optionally, a plurality of shaped templates may be predetermined, where the shaped template may be of a regular shape such as a triangle, a circle, or a square, or may be a user-defined shape, which is not limited in the present disclosure. When the region selection operation triggered by the user for the image to be processed is obtained, the at least one shaped template that is predetermined may be displayed for user to select. In response to a selection operation performed by the user for the shaped template, a target shaped template selected by the user is determined. After the target shaped template is determined, in response to a moving operation by the user on the target shaped template, a region in which the moved target shaped template is located as the region to be processed may be determined.

In practical applications, one or more of the above region selection methods may be used to determine the region to be processed, which is not limited in the present disclosure. For example, in response that the region to be processed is determined by using a plurality of region selection methods, after the region to be processed is obtained by automatically identifying or selecting the shaped template, the user may further perform an editing operation on the region to be processed in a way of painting.

Further, on the basis of any one of the above embodiments, step 102 includes:
generating a mask to be processed matching the region to be processed according to the region to be processed, wherein in the mask to be processed, pixel values of the region to be processed are different from pixel values of other regions.
in response to a second editing request triggered by the user for the mask to be processed, performing a second editing operation on the mask to be processed to obtain the target mask.

The second editing operation comprises one or more of a moving operation, a zooming operation, a rotation operation, a flipping operation.

In this embodiment, in order to improve the effect of image processing, in the process of generating the target mask, the user may perform a mask editing operation according to actual requirements.

Optionally, after obtaining the region to be processed, a mask to be processed matching the region to be processed may be generated based on the region to be processed, where the region to be processed is a sampling region, and the other regions are non-sampling regions. The pixel values of the sampling region are different from the pixel values of the non-sampling region. For example, a pixel value of the sampling region may be 1, and a pixel value of the non-sampling region may be 0.

In practical applications, since the region to be processed may be specifically generated by manually painting or automatically identifying the user according to actual requirements, it is often possible that the precision is poor, or the personalized requirement of the user is not satisfied, and then the mask to be processed may not meet the actual needs of the user.

In order to improve the accuracy of image processing, after obtaining the mask to be processed, a second editing operation may be further performed on the mask to be processed in response to a second editing request triggered by the user for the mask to be processed to obtain the target mask. The second editing operation includes one or more of a moving operation, a zooming operation, a rotation operation, a flipping operation. Therefore, by triggering the second editing operation, the size, the position, the direction and the like of the mask to be processed may be adjusted to make the mask more suitable for the personalized requirement of the user.

According to the method of image processing provided by the embodiment, the second editing operation is carried out on the mask to be processed in response to the second editing request triggered by the user in the generation process of the target mask, so that the target mask may be more suitable for the requirement of the user, the accuracy of the sampling region generated according to the target mask may be improved, and the image processing effect may be optimized.

Further, on the basis of any one of the above embodiments, step 102 includes:
performing a blend operation on the target mask and the image to be processed to obtain the sampling region.

In the embodiment, after the target mask is obtained, the target mask may be blended with the image to be processed to obtain a sampling region.

Specifically, the target mask and the region to be processed may be blended according to the transparency of the target mask to obtain the sampling region.

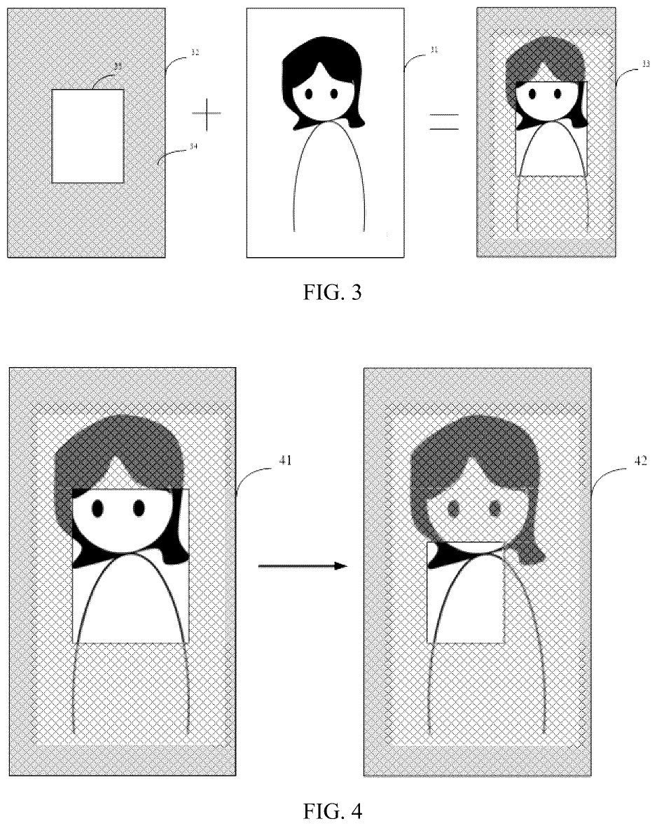

FIG. 3 is a schematic diagram of generating a sampling region according to an embodiment of the present disclosure. The target mask 32 includes a non-sampling region 34 and a sampling region 35.

Further, on the basis of any one of the above embodiments, step 103 includes:
in response to an operation gesture triggered by the user for the sampling region, determining editing content matching the operation gesture, performing the first editing operation on the sampling region according to the editing content, and determining the edited target region as the target image, wherein the editing content comprises one or more of moving editing content, zooming editing content, rotating editing content.
and/or, in response to a trigger operation by the user on at least one first editing control associated with the sampling region, performing the first editing operation on the sampling region, and determining the edited target region as the target image, wherein the first editing control comprises an editing control for flipping and an editing control for deleting.
and/or, in response to a trigger operation by the user on at least one second editing control associated with the sampling region, displaying an adjustment control corresponding to the first editing control, in response to an adjustment parameter input by the user by triggering the adjustment control, performing the first editing operation on the sampling region according to the adjustment parameter, and determining the edited target region as the target image, wherein the second editing control comprises an editing control for adjusting a transparency and an editing control for adjusting a feathering degree.

In this embodiment, the first editing operation may specifically include one or more of moving, zooming, rotating, flipping, deleting, modifying transparency, modifying feathering degree. Different trigger operations may be corresponding to different first editing operations.

Optionally, when the first editing operation is one or more of moving, zooming, rotating, the user may trigger different operation gestures on the display interface to trigger the first editing operation. In response to the operation gesture triggered by the user for the sampling region, the editing content matching the operation gesture is determined, the first editing operation is performed on the sampling region according to the editing content, and the edited target region is determined as the target image. For example, the user may implement the moving operation on the sampling region by dragging. The scaling operation on the sampling region may be achieved by a pinching operation of at least two fingers. The rotation operation on the sampling region may be achieved by twisting at least two fingers.

Optionally, when the first editing operation is flipping and/or deleting, the association position of the sampling region may display a related first editing control. For example, the upper left corner of the sampling region may display an editing control for closing, an editing control for flipping, and the like. Therefore, in response to the trigger operation performed by the user on the at least one first editing control associated with the sampling region, the first editing operation is performed on the sampling region, and the edited target region is determined as the target image.

Optionally, when the first editing operation is to modify the transparency and/or modify the feathering degree, the predetermined display position in the display interface may further display a related second editing control. In response to the trigger operation of the user on the at least one second editing control associated with the sampling region, the adjustment control corresponding to the first editing control is displayed, in response to the adjustment parameter input by the user through triggering the adjustment control, the first editing operation is performed on the sampling region according to the adjustment parameter, the edited target region is determined as the target image, and the second editing control includes an editing control for adjusting a transparency and an editing control for adjusting a feathering degree.

FIG. 4 is a schematic diagram of editing a sampling region according to an embodiment of the present disclosure.

According to the method of image processing provided in this embodiment, a plurality of different editing request triggering operations is set, so that the user may more flexibly trigger the first editing request, and then the first editing operation on the sampling region may be flexibly implemented, so that the target image obtained based on the sampling region is more suitable for the personalized requirement of the user.

Further, on the basis of any one of the foregoing embodiments, the second editing control includes an editing control for adjusting a transparency. The performing the first editing operation on the sampling region according to the adjustment parameter, and determining the edited target region as the target image includes:
adjusting transparency of a predetermined channel corresponding to the sampling region according to the adjustment parameter to obtain a target image.

In this embodiment, in response that the first editing operation is an operation of adjusting the transparency, the adjustment parameter determined by the user based on the operation of adjusting the transparency may be determined. The operation of adjusting the transparency is performed on the sampling region based on the adjustment parameter.

In practical applications, the image to be processed is generally an RGBA image. Therefore, in the process of adjusting the transparency, the transparency of the predetermined channel corresponding to the sampling region may be adjusted according to the adjustment parameter to obtain the target image. The predetermined channel may be specifically an Alpha channel.

Further, on the basis of any one of the foregoing embodiments, the second editing control includes an editing control for adjusting feathering degree. The performing the first editing operation on the sampling region according to the adjustment parameter, and determining the edited target region as the target image includes:
determining a feathering range matching the adjustment parameter according to the adjustment parameter.
adjusting transparency of a predetermined channel corresponding to the feathering range to obtain the target image.

The adjustment parameter is proportional to the feathering range.

In this embodiment, in response that the first editing operation is the editing operation for adjusting the feathering degree, the first editing operation may be specifically adjusting the transparency of the feathering range. The adjustment parameter may be specifically used to determine a feathering range, and the larger the adjustment parameter is, the greater the feathering range. The feathering range may be a range at an edge of the sampling region, or may be a center range of the sampling region, or may be a range of an unspecified position in the sampling region, which is not limited in the present disclosure.

After obtaining the adjustment parameter, the feathering range matching the adjustment parameter may be determined according to the adjustment parameter. Adjusting transparency of a predetermined channel corresponding to the feathering range to obtain a target image. In the process of adjusting the transparency, the transparency of the predetermined channel corresponding to the sampling region may be adjusted according to the adjustment parameter. The predetermined channel may be specifically an Alpha channel.

According to the method of image processing provided by the embodiment, the first editing operation is performed on the sampling region, so that the accuracy of region extraction may be improved, and the generated target image is more suitable for the personalized requirement of the user.

FIG. 5 is a schematic flowchart of a method of image processing method according to still another embodiment of the present disclosure.

Step 501: determine each processing operation triggered by the user for the image to be processed, and determine operation information corresponding to the processing operation, where the operation information includes one or more of a field name, an operation type, an operation specification.

Step 502: store in association each processing operation and the operation information corresponding to the processing operation.

The processing operation includes one or more of a region selection operation, a first editing operation, a second editing operation.

In this embodiment, in the image processing process, the user may view the actual imaging effect in real time, and if it is determined according to the actual imaging effect that the result generated by one or more processing operations in the processing process is unsatisfactory, there is a demand for returning or restoring the operation result. Therefore, in order to enable the backoff of the processing operation, each processing operation triggered by the user for the image to be processed may be determined, and the operation information corresponding to the processing operation is determined, where the operation information includes one or more of a field name, an operation type, and an operation specification.

An association relationship between the processing operation and the operation information is established, and the processing operation and the operation information corresponding to the processing operation are stored in association.

For example, the processing operation may include one or more of a region selection operation, a first editing operation, and a second editing operation.

Further, on the basis of any one of the above embodiments, after step 502, the method further includes:
in response to a backoff request triggered by the user, determining a target processing operation corresponding to the backoff request.
obtaining operation information corresponding to the target processing operation.
performing a re-rendering operation on the image to be processed according to the operation information, so that a processing progress of the image to be processed falls back to the target processing operation.

In this embodiment, when the actual imaging effect of the one or more processing operations does not meet the actual requirement of the user, the user may perform a triggering operation on the predetermined backoff control to implement the backoff of the processing operation.

Optionally, the target processing operation corresponding to the backoff request is determined in response to the backoff request triggered by the user. The operation information corresponding to the target processing operation is obtained according to an association relationship between the target processing operation and the operation information. Therefore, the image to be processed may be re-rendered according to the operation information corresponding to the target processing operation, so that the processing progress of the image to be processed falls back to the target processing operation, and the actual imaging effect corresponding to the target processing operation is displayed.

According to the method of image processing provided by the embodiment, the operation information corresponding to each processing operation is stored, so that the backoff of the processing operation may be carried out subsequently based on the operation information, so that the image processing process is more suitable for the actual requirement of the user, and the user experience is improved.

Further, on the basis of any one of the above embodiments, after step 103, the method further includes:
storing the target image and the target mask to a predetermined storage path.

In this embodiment, the user may trigger multiple rounds of image processing operations for the image to be processed, and for each round of image processing operation, each processing operation may be stored in association with its corresponding operation information, so that the processing operation of each step is traceable. Because one rendering node is added to each image processing, the rendering node includes one image to be processed, one target mask, and all operation information of the current processing operation, therefore, when the rendering node is too large, the usage of the memory is large, and the processing time is long.

In order to avoid latency in the image processing process, the target image and the target mask may be stored in a predetermined storage path, where the storage path may be a disk. Through the transfer operation on the target image and the target mask, the data in the memory may be released, so that the performance degradation caused by multiple image processing is avoided.

Further, on the basis of any one of the above embodiments, after the storing the target image and the target mask to a predetermined storage path, the method further includes:
performing a third editing operation on the target image in response to a third editing request triggered by the user for the target image.

In this embodiment, after the first editing operation on the sampling region is completed to obtain the target image, the user may further perform image processing on the target image according to actual requirements. Therefore, the third editing operation may be performed on the target image in response to the third editing request triggered by the user for the target image. In response to performing the third editing operation on the target image, a target image, a target mask, and all operation information of the secondary processing operation are correspondingly stored.

Further, on the basis of any one of the above embodiments, after the performing a third editing operation on the target image in response to a third editing request triggered by the user for the target image, the method further includes:
in response to the backoff request triggered by the user, determining a target processing operation corresponding to the backoff request;
in response that the target processing operation matches any processing operation corresponding to the target image, obtaining the target image and the target mask from a predetermined storage path.
processing the backoff request according to the target image and the target mask.

The processing operation includes one or more of a region selection operation, a first editing operation, and a second editing operation.

In this embodiment, after the user performs the multi-round image processing operation on the image to be processed, in response that the user triggers the backoff operation, performing the backoff operation step by step usually takes a long time and is cumbersome to operate. Therefore, the target processing operation corresponding to the backoff request may be determined in response to the backoff request triggered by the user, and if any processing operation corresponding to the target image matches any processing operation corresponding to the target image, the target image and the target mask are obtained from the predetermined storage path. Therefore, a gradual backoff operation does not need to be performed, and the backoff request may be directly processed on the basis of the target image. Therefore, the image processing efficiency may be improved.

According to the method of image processing provided by the embodiment, the target image and the target mask are stored, so that the data in the memory may be released, so that the performance degradation caused by multiple restorations is avoided. In addition, the backoff of the processing operation may be implemented based on the target image and the target mask, so that the image processing process is more suitable for the actual requirement of the user, and the user experience is improved.

Further, on the basis of any one of the above embodiments, after step 103, the method further includes:
performing an image restoration operation on the image to be processed according to the target image;
or, storing the target image.

In this embodiment, after the target image is obtained, an image restoration operation may be performed on the image to be processed based on the target image. For example, the target image may be moved to the region that needs to be restored, and the region to be restored has been covered to implement the image restoration operation.

Or, the plurality of target images may be copied, and in response to the moving operation performed by the user on the plurality of target images, the plurality of target images is displayed on the image to be processed to implement beautification of the image to be processed.

Or, the target image may also be stored for subsequent use of the target image.

Further, on the basis of any one of the above embodiments, the performing an image restoration operation on the image to be processed according to the target image includes:
in response to a moving operation triggered by the user for the target image, moving the target image to a region to be restored;
covering the target image on top of the region to be restored to obtain a restored image to be processed.

In this embodiment, after performing the first editing operation on the sampling region to obtain the target image, the user may perform a moving operation on the target image. In response to the moving operation triggered by the user for the target image, the target image may be moved to the region to be restored. The target image is overlaid on the top of the region to be restored, that is, the image to be processed may be restored to obtain the restored image to be processed.

Optionally, after moving the target image to the region to be restored, in order to improve the fusion degree between the target image and the image to be processed, the edge, transparency and the like of the target image may be edited in response to an editing operation triggered by the user.

According to the method of image processing provided by the embodiment, the image restoration operation is carried out according to the target image, so that the image quality of the restored image may be effectively improved.

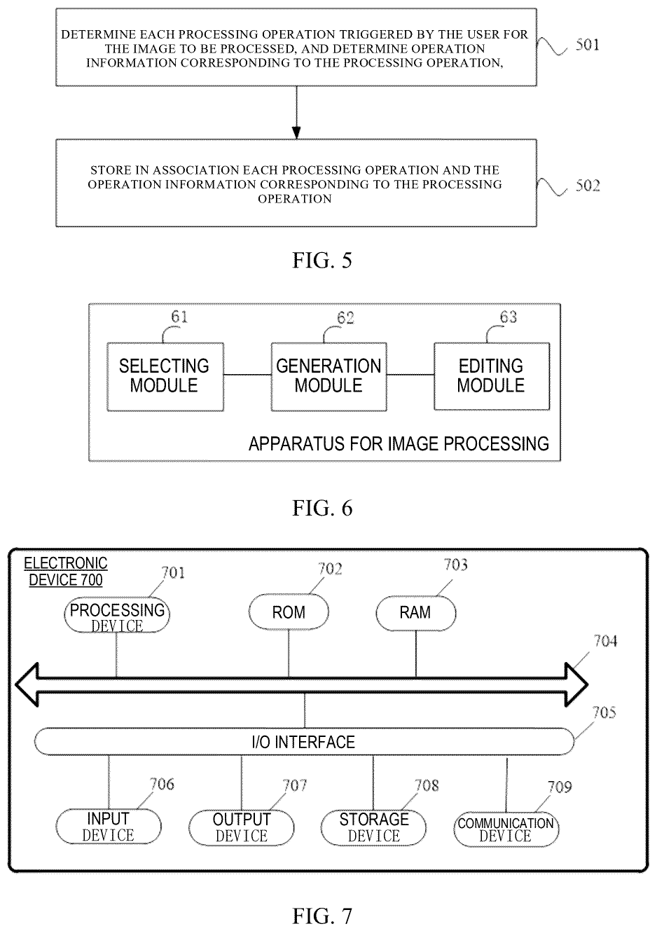

FIG. 6 is a schematic structural diagram of an apparatus for image processing according to an embodiment of the present disclosure. The selecting module 61 is configured to, in response to a region selection operation triggered by a user for an image to be processed, determine a region to be processed in the image to be processed. The generation module 62 is configured to generate a target mask based on the region to be processed and generate a sampling region according to the target mask and the image to be processed. An editing module 63, configured to, in response to a first editing request triggered by the user, perform a first editing operation on the sampling region and determine the edited target region as a target image.

Further, on the basis of any one of the above embodiments, the selecting module is configured to: in response to a painting operation triggered by the user on the image to be processed, determine a painting region corresponding to the painting operation, and determine the painting region as the region to be processed; or, in response to an object recognition request triggered by the user for the image to be processed, perform a recognition operation on at least one predetermined object in the image to be processed, and in response to a selection operation by the user on the at least one predetermined object, determine a region in which the predetermined object selected by the user is located as the region to be processed; or, in response to the region selection operation triggered by the user for the image to be processed, display at least one shaped template that is predetermined and determine a target shaped template selected by the user, and in response to a moving operation by the user on the target shaped template, determine a region in which the moved target shaped template is located as the region to be processed.

Further, on the basis of any one of the above embodiments, the generation module is configured to: generate a mask to be processed matching the region to be processed according to the region to be processed, where in the mask to be processed, pixel values of the region to be processed are different from pixel values of other regions; in response to a second editing request triggered by the user for the mask to be processed, perform a second editing operation on the mask to be processed to obtain the target mask; wherein the second editing operation includes one or more of a moving operation, a zooming operation, a rotation operation, a flipping operation.

Further, on the basis of any one of the above embodiments, the generation module is configured to: perform a blend operation on the target mask and the image to be processed to obtain the sampling region.

Further, on the basis of any one of the above embodiments, the editing module is configured to: in response to an operation gesture triggered by the user for the sampling region, determine editing content matching the operation gesture, perform the first editing operation on the sampling region according to the editing content, and determine the edited target region as the target image, where the editing content includes one or more of moving editing content, zooming editing content, rotating editing content; and/or, in response to a trigger operation by the user on at least one first editing control associated with the sampling region, perform the first editing operation on the sampling region, and determine the edited target region as the target image, where the first editing control includes an editing control for flipping and an editing control for deleting; and/or, in response to a trigger operation by the user on at least one second editing control associated with the sampling region, display an adjustment control corresponding to the first editing control, in response to an adjustment parameter input by the user by triggering the adjustment control, perform the first editing operation on the sampling region according to the adjustment parameter, and determine the edited target region as the target image, where the second editing control includes an editing control for adjusting a transparency and an editing control for adjusting a feathering degree.

Further, on the basis of any one of the foregoing embodiments, the second editing control includes an editing control for adjusting a transparency. The editing module is configured to: adjust transparency of a predetermined channel corresponding to the sampling region according to the adjustment parameter to obtain the target image.

Further, on the basis of any one of the foregoing embodiments, the second editing control includes an editing control for adjusting a feathering degree. The editing module is configured to determine a feathering range matching the adjustment parameter according to the adjustment parameter; adjust transparency of a predetermined channel corresponding to the feathering range to obtain the target image. The adjustment parameter is proportional to the feathering range.

Further, on the basis of any one of the foregoing embodiments, the apparatus further includes: a determining module, configured to determine each processing operation triggered by the user for the image to be processed, and determine operation information corresponding to the processing operation, where the operation information includes one or more of a field name, an operation type, an operation specification; a storage module, configured to storing in association each processing operation and the operation information corresponding to the processing operation; where the processing operation includes one or more of a region selection operation, a first editing operation, a second editing operation.

Further, on the basis of any one of the foregoing embodiments, the apparatus further includes: a determining module, configured to, in response to a backoff request triggered by the user, determine a target processing operation corresponding to the backoff request; an obtaining module, configured to obtain operation information corresponding to the target processing operation; a processing module, configured to perform a re-rendering operation on the image to be processed according to the operation information, so that a processing progress of the image to be processed falls back to the target processing operation.

Further, on the basis of any one of the above embodiments, the apparatus further includes: a storage module, configured to store the target image and the target mask to a predetermined storage path.

Further, on the basis of any one of the above embodiments, the apparatus further includes: an editing module, configured to perform a third editing operation on the target image in response to a third editing request triggered by the user for the target image.

Further, on the basis of any one of the foregoing embodiments, the apparatus further includes: a determining module, configured to, in response to the backoff request triggered by the user, determine a target processing operation corresponding to the backoff request; an obtaining module, configured to in response that the target processing operation matches any processing operation corresponding to the target image, obtain the target image and the target mask from a predetermined storage path; a processing module, configured to process the backoff request according to the target image and the target mask. The processing operation includes one or more of a region selection operation, a first editing operation, and a second editing operation.

Further, on the basis of any one of the above embodiments, the apparatus further includes: a restoration module, configured to perform an image restoration operation on the image to be processed according to the target image; or, store the target image.

Further, on the basis of any one of the above embodiments, the restoration module is configured to: in response to a moving operation triggered by the user for the target image, move the target image to a region to be restored;
cover the target image on top of the region to be restored to obtain a restored image to be processed.

The apparatus provided in this embodiment may be configured to perform the technical solutions in the foregoing method embodiments, and implementation principles and technical effects thereof are similar, and details are not described herein again in this embodiment.

In order to implement the foregoing embodiments, an embodiment of the present disclosure further provides an electronic device, including: a processor and a memory.

The memory stores computer-executable instructions.

The processor executes the computer-executable instructions stored in the memory, to cause the processor to perform the method of image processing according to any one of the above embodiments.

FIG. 7 is a schematic structural diagram of an electronic device according to an embodiment of the present disclosure. The terminal device may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device shown in FIG. 7 is merely an example, and should not impose any limitation on the functions and scope of use of the embodiments of the present disclosure.

As shown in FIG. 7, the electronic device 700 may include a processing device (for example, a central processing unit, a graphics processor, etc.) 701, which may perform various appropriate actions and processing according to a program stored in a read only memory (ROM) 702 or a program loaded into a random access memory (RAM) 703 from a storage device 708. In the RAM 703, various programs and data required by the operation of the electronic device 700 are also stored. The processing device 701, the ROM 702, and the RAM 703 are connected to each other through a bus 704. Input/output (I/O) interface 705 is also connected to bus 704.

Generally, the following devices may be connected to the I/O interface 705: an input device 706 including, for example, a touch screen, a touch pad, a keyboard, a mouse, a camera, a microphone, an accelerometer, a gyroscope, etc. ; an output device 707 including, for example, a liquid crystal display (LCD), a speaker, a vibrator, etc. ; a storage device 708 including, for example, a magnetic tape, a hard disk, etc.; and a communication device 709. The communication device 709 may allow the electronic device 700 to communicate wirelessly or wired with other devices to exchange data. While FIG. 7 shows an electronic device 700 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program embodied on a computer readable medium, the computer program comprising program code for performing the method shown in the flowchart. In such embodiments, the computer program may be downloaded and installed from the network through the communication device 709, or installed from the storage device 708, or from the ROM 702. When the computer program is executed by the processing apparatus 701, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM) or a flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables, Radio Frequency (RF), and the like, or any suitable combination thereof.

An embodiment of the present disclosure further provides a computer-readable storage medium, where the computer-readable storage medium stores a computer-executable instructions, and the computer-executable instructions, when executed by the processor, implement the method of image processing according to any one of the foregoing embodiments is implemented.

An embodiment of the present disclosure further provides a computer program product, including a computer program, where the computer program, when executed by a processor, implements the method of image processing according to any one of the foregoing embodiments.

An embodiment of the present disclosure further provides a computer program, which, when executed by a processor, implements the method of image processing according to any one of the foregoing embodiments.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local region network (LAN) or a wide region network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “obtaining at least two units of Internet Protocol addresses”.

The functions described above may be performed, at least in part, by one or more hardware logic components. For example, without limitation, the exemplary types of hardware logic components that may be used include: Field-Programmable Gate Array (FPGA), Application Specific Integrated Circuit (ASIC), Application Specific Standard (ASSP), System On Chip (SOC), Complex Programmable Logic Device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to a first aspect, a method of image processing is provided according to one or more embodiments of the present disclosure, including:
in response to a region selection operation triggered by a user for an image to be processed, determining a region to be processed in the image to be processed;
generating a target mask based on the region to be processed, and generating a sampling region according to the target mask and the image to be processed;
in response to a first editing request triggered by the user, performing a first editing operation on the sampling region and determining the edited target region as a target image.

According to one or more embodiments of the present disclosure, the in response to a region selection operation triggered by the user for the image to be processed, determining a region to be processed in the image to be processed includes:
in response to a painting operation triggered by the user on the image to be processed, determining a painting region corresponding to the painting operation, and determining the painting region as the region to be processed;
or, in response to an object recognition request triggered by the user for the image to be processed, performing a recognition operation on at least one predetermined object in the image to be processed, and in response to a selection operation by the user on the at least one predetermined object, determining a region in which the predetermined object selected by the user is located as the region to be processed.
or, in response to the region selection operation triggered by the user for the image to be processed, displaying at least one shaped template that is predetermined and determining a target shaped template selected by the user, and in response to a moving operation by the user on the target shaped template, determining a region in which the moved target shaped template is located as the region to be processed.

According to one or more embodiments of the present disclosure, the generating a target mask based on the region to be processed includes:
generating a mask to be processed matching the region to be processed according to the region to be processed, wherein in the mask to be processed, pixel values of the region to be processed are different from pixel values of other regions;
in response to a second editing request triggered by the user for the mask to be processed, performing a second editing operation on the mask to be processed to obtain the target mask;
wherein the second editing operation comprises one or more of a moving operation, a zooming operation, a rotation operation, a flipping operation.

According to one or more embodiments of the present disclosure, the generating a sampling region according to the target mask and the image to be processed includes:
performing a blend operation on the target mask and the image to be processed to obtain the sampling region.

According to one or more embodiments of the present disclosure, the in response to a first editing request triggered by the user, performing a first editing operation on the sampling region and determining the edited target region as a target image includes:
in response to an operation gesture triggered by the user for the sampling region, determining editing content matching the operation gesture, performing the first editing operation on the sampling region according to the editing content, and determining the edited target region as the target image, wherein the editing content comprises one or more of moving editing content, zooming editing content, rotating editing content;
and/or, in response to a trigger operation by the user on at least one first editing control associated with the sampling region, performing the first editing operation on the sampling region, and determining the edited target region as the target image, wherein the first editing control comprises an editing control for flipping and an editing control for deleting;
and/or, in response to a trigger operation by the user on at least one second editing control associated with the sampling region, displaying an adjustment control corresponding to the first editing control, in response to an adjustment parameter input by the user by triggering the adjustment control, performing the first editing operation on the sampling region according to the adjustment parameter, and determining the edited target region as the target image, wherein the second editing control comprises an editing control for adjusting a transparency and an editing control for adjusting a feathering degree.

According to one or more embodiments of the present disclosure, the second editing control includes an editing control for adjusting a transparency.

The performing the first editing operation on the sampling region according to the adjustment parameter, and determining the edited target region as the target image includes:
adjusting transparency of a predetermined channel corresponding to the sampling region according to the adjustment parameter to obtain the target image.

According to one or more embodiments of the present disclosure, the second editing control includes an editing control for adjusting a feathering degree.

The performing the first editing operation on the sampling region according to the adjustment parameter, and determining the edited target region as the target image includes:
determining a feathering range matching the adjustment parameter according to the adjustment parameter;
adjusting transparency of a predetermined channel corresponding to the feathering range to obtain the target image;
where the adjustment parameter is proportional to the feathering range.

According to one or more embodiments of the present disclosure, the method further includes:
determining each processing operation triggered by the user for the image to be processed, and determining operation information corresponding to the processing operation, wherein the operation information comprises one or more of a field name, an operation type, an operation specification;
storing in association each processing operation and the operation information corresponding to the processing operation;
where the processing operation includes one or more of a region selection operation, a first editing operation, a second editing operation.

According to one or more embodiments of the present disclosure, after the storing in association each processing operation and the operation information corresponding to the processing operation, the method further includes:
in response to a backoff request triggered by the user, determining a target processing operation corresponding to the backoff request.
obtaining operation information corresponding to the target processing operation;
performing a re-rendering operation on the image to be processed according to the operation information, so that a processing progress of the image to be processed falls back to the target processing operation.

According to one or more embodiments of the present disclosure, after the performing a first editing operation on the sampling region in response to the first editing request triggered by the user, and determining the edited target region as a target image, the method further includes:
storing the target image and the target mask to a predetermined storage path.

According to one or more embodiments of the present disclosure, after the storing the target image and the target mask to a predetermined storage path, the method further includes:
performing a third editing operation on the target image in response to a third editing request triggered by the user for the target image.

According to one or more embodiments of the present disclosure, after the performing a third editing operation on the target image in response to a third editing request triggered by the user for the target image, the method further includes:
in response to the backoff request triggered by the user, determining a target processing operation corresponding to the backoff request;
in response that the target processing operation matches any processing operation corresponding to the target image, obtaining the target image and the target mask from a predetermined storage path.
processing the backoff request according to the target image and the target mask.

The processing operation includes one or more of a region selection operation, a first editing operation, and a second editing operation.

According to one or more embodiments of the present disclosure, after the in response to a first editing request triggered by the user, performing the first editing operation on the sampling region and determining the edited target region as a target image, the method further includes:
performing an image restoration operation on the image to be processed according to the target image;
or, storing the target image.

According to one or more embodiments of the present disclosure, the performing an image restoration operation on the image to be processed according to the target image includes:
in response to a moving operation triggered by the user for the target image, moving the target image to a region to be restored;
covering the target image on top of the region to be restored to obtain a restored image to be processed.

According to a second aspect, an apparatus for image processing is provided according to one or more embodiments of the present disclosure, including:
a selecting module configured to, in response to a region selection operation triggered by a user for an image to be processed, determine a region to be processed in the image to be processed;
a generation module configured to generate a target mask based on the region to be processed, and generate a sampling region according to the target mask and the image to be processed; and
an editing module configured to, in response to a first editing request triggered by the user, perform a first editing operation on the sampling region and determine the edited target region as a target image.

According to one or more embodiments of the present disclosure, the selecting module is configured to:
in response to a painting operation triggered by the user on the image to be processed, determine a painting region corresponding to the painting operation, and determine the painting region as the region to be processed;
or, in response to an object recognition request triggered by the user for the image to be processed, perform a recognition operation on at least one predetermined object in the image to be processed, and in response to a selection operation by the user on the at least one predetermined object, determine a region in which the predetermined object selected by the user is located as the region to be processed;
or, in response to the region selection operation triggered by the user for the image to be processed, displaying at least one shaped template that is predetermined and determining a target shaped template selected by the user, and in response to a moving operation by the user on the target shaped template, determining a region in which the moved target shaped template is located as the region to be processed.

According to one or more embodiments of the present disclosure, the generation module is configured to:
generate a mask to be processed matching the region to be processed according to the region to be processed, where in the mask to be processed, pixel values of the region to be processed are different from pixel values of other regions;
in response to a second editing request triggered by the user for the mask to be processed, perform a second editing operation on the mask to be processed to obtain the target mask;
where the second editing operation includes one or more of a moving operation, a zooming operation, a rotation operation, a flipping operation.

According to one or more embodiments of the present disclosure, the generation module is configured to:
performing a blend operation on the target mask and the image to be processed to obtain the sampling region.

According to one or more embodiments of the present disclosure, the editing module is configured to:
in response to an operation gesture triggered by the user for the sampling region, determine editing content matching the operation gesture, perform the first editing operation on the sampling region according to the editing content, and determine the edited target region as the target image, where the editing content comprises one or more of moving editing content, zooming editing content, rotating editing content;
and/or, in response to a trigger operation by the user on at least one first editing control associated with the sampling region, perform the first editing operation on the sampling region, and determine the edited target region as the target image, where the first editing control comprises an editing control for flipping and an editing control for deleting;
and/or, in response to a trigger operation by the user on at least one second editing control associated with the sampling region, displaying an adjustment control corresponding to the first editing control, in response to an adjustment parameter input by the user by triggering the adjustment control, performing the first editing operation on the sampling region according to the adjustment parameter, and determining the edited target region as the target image, wherein the second editing control comprises an editing control for adjusting a transparency and an editing control for adjusting a feathering degree.

According to one or more embodiments of the present disclosure, the second editing control includes an editing control for adjusting a transparency.

The editing module is configured to:
adjust transparency of a predetermined channel corresponding to the sampling region according to the adjustment parameter to obtain the target image.

According to one or more embodiments of the present disclosure, the second editing control includes an editing control for adjusting a feathering degree.

The editing module is configured to:
determine a feathering range matching the adjustment parameter according to the adjustment parameter;
adjust transparency of a predetermined channel corresponding to the feathering range to obtain the target image;

The adjustment parameter is proportional to the feathering range.

According to one or more embodiments of the present disclosure, the apparatus further includes:
a determining module, configured to each processing operation triggered by the user for the image to be processed, and determining operation information corresponding to the processing operation, wherein the operation information comprises one or more of a field name, an operation type, an operation specification; and
a storage module, configured to store in association each processing operation and the operation information corresponding to the processing operation;

The processing operation includes one or more of a region selection operation, a first editing operation, and a second editing operation.

According to one or more embodiments of the present disclosure, the apparatus further includes:
the determining module is further configured to, in response to a backoff request triggered by the user, determine a target processing operation corresponding to the backoff request;
an obtaining module, configured to obtain operation information corresponding to the target processing operation; and
a processing module, configured to perform a re-rendering operation on the image to be processed according to the operation information, so that a processing progress of the image to be processed falls back to the target processing operation.

According to one or more embodiments of the present disclosure, the apparatus further includes:
a storage module, configured to store the target image and the target mask to a predetermined storage path.

According to one or more embodiments of the present disclosure, the apparatus further includes:
an editing module, configured to perform a third editing operation on the target image in response to a third editing request triggered by the user for the target image.

According to one or more embodiments of the present disclosure, the apparatus further includes:
a determining module, configured to, in response to the backoff request triggered by the user, determine a target processing operation corresponding to the backoff request; and
an obtaining module, configured to in response that the target processing operation matches any processing operation corresponding to the target image, obtain the target image and the target mask from a predetermined storage path;
a processing module, configured to process the backoff request according to the target image and the target mask.

The processing operation includes one or more of a region selection operation, a first editing operation, and a second editing operation.

According to one or more embodiments of the present disclosure, the apparatus further includes:
a restoration module, configured to perform an image restoration operation on the image to be processed according to the target image;
or, the storage module is configured to store the target image.

According to one or more embodiments of the present disclosure, the restoration module is configured to:
in response to a moving operation triggered by the user for the target image, move the target image to a region to be restored;
cover the target image on top of the region to be restored to obtain a restored image to be processed.

According to a third aspect, an electronic device is provided according to one or more embodiments of the present disclosure, including: at least one processor and a memory;
the memory stores computer executable instructions;
the at least one processor executes the computer-executable instructions stored in the memory, to cause the at least one processor to perform the method of image processing according to the first aspect and various possible designs of the first aspect.

According to a fourth aspect, a computer-readable storage medium is provided according to one or more embodiments of the present disclosure, where the computer-readable storage medium stores computer-executable instructions, and the computer-executable instructions, when executed by the processor, implement the method of the image processing according to the first aspect and the possible designs of the first aspect is implemented.

According to a fifth aspect, a computer program product is provided according to one or more embodiments of the present disclosure, including a computer program, where the computer program, when executed by a processor, implements the method of image processing according to the first aspect and various possible designs of the first aspect.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method of image processing, comprising:
in response to a region selection operation triggered by a user for an image to be processed, determining a region to be processed in the image to be processed;
generating a target mask based on the region to be processed, and generating a sampling region according to the target mask and the image to be processed;
in response to a first editing request triggered by the user, performing a first editing operation on the sampling region and determining the edited target region as a target image.

2. The method of claim 1, wherein the in response to a region selection operation triggered by the user for the image to be processed, determining a region to be processed in the image to be processed comprises:
in response to a painting operation triggered by the user on the image to be processed, determining a painting region corresponding to the painting operation, and determining the painting region as the region to be processed;
or,
in response to an object recognition request triggered by the user for the image to be processed, performing a recognition operation on at least one predetermined object in the image to be processed, and in response to a selection operation by the user on the at least one predetermined object, determining a region in which the predetermined object selected by the user is located as the region to be processed;
or,
in response to the region selection operation triggered by the user for the image to be processed, displaying at least one shaped template that is predetermined and determining a target shaped template selected by the user, and in response to a moving operation by the user on the target shaped template, determining a region in which the moved target shaped template is located as the region to be processed.

3. The method of claim 1, wherein the generating a target mask based on the region to be processed comprises:
generating a mask to be processed matching the region to be processed according to the region to be processed, wherein in the mask to be processed, pixel values of the region to be processed are different from pixel values of other regions;
in response to a second editing request triggered by the user for the mask to be processed, performing a second editing operation on the mask to be processed to obtain the target mask;
wherein the second editing operation comprises one or more of a moving operation, a zooming operation, a rotation operation, a flipping operation.

4. The method of claim 1, wherein the generating a sampling region according to the target mask and the image to be processed comprises:
performing a blend operation on the target mask and the image to be processed to obtain the sampling region.

5. The method of claim 1, wherein the in response to a first editing request triggered by the user, performing a first editing operation on the sampling region and determining the edited target region as a target image comprises:
in response to an operation gesture triggered by the user for the sampling region, determining editing content matching the operation gesture, performing the first editing operation on the sampling region according to the editing content, and determining the edited target region as the target image, wherein the editing content comprises one or more of moving editing content, zooming editing content, rotating editing content;
and/or,
in response to a trigger operation by the user on at least one first editing control associated with the sampling region, performing the first editing operation on the sampling region, and determining the edited target region as the target image, wherein the first editing control comprises an editing control for flipping and an editing control for deleting;
and/or,
in response to a trigger operation by the user on at least one second editing control associated with the sampling region, displaying an adjustment control corresponding to the first editing control, in response to an adjustment parameter input by the user by triggering the adjustment control, performing the first editing operation on the sampling region according to the adjustment parameter, and determining the edited target region as the target image, wherein the second editing control comprises an editing control for adjusting a transparency and an editing control for adjusting a feathering degree.

6. The method of claim 1, further comprising:
determining each processing operation triggered by the user for the image to be processed, and determining operation information corresponding to the processing operation, wherein the operation information comprises one or more of a field name, an operation type, an operation specification;
storing in association each processing operation and the operation information corresponding to the processing operation;
the processing operation comprises one or more of a region selection operation, a first editing operation, a second editing operation.

7. The method of claim 6, wherein after the storing in association each processing operation and the operation information corresponding to the processing operation, the method further comprises:
in response to a backoff request triggered by the user, determining a target processing operation corresponding to the backoff request;
obtaining operation information corresponding to the target processing operation;
performing a re-rendering operation on the image to be processed according to the operation information, so that a processing progress of the image to be processed falls back to the target processing operation.

8. The method of claim 1, wherein after the performing a first editing operation on the sampling region in response to the first editing request triggered by the user, and determining the edited target region as a target image, the method further comprises:
storing the target image and the target mask to a predetermined storage path.

9. The method of claim 1, wherein after the in response to a first editing request triggered by the user, performing the first editing operation on the sampling region and determining the edited target region as a target image, the method further comprises:
performing an image restoration operation on the image to be processed according to the target image;
or,
storing the target image.

10. The method of claim 9, wherein the performing an image restoration operation on the image to be processed according to the target image comprises:
in response to a moving operation triggered by the user for the target image, moving the target image to a region to be restored;
covering the target image on top of the region to be restored to obtain a restored image to be processed.

11. (canceled)

12. An electronic device, comprising: a processor and a memory;
the memory storing computer executable instructions;
the processor executing the computer-executable instructions stored in the memory, to cause the processor to perform acts comprising:
in response to a region selection operation triggered by a user for an image to be processed, determining a region to be processed in the image to be processed;
generating a target mask based on the region to be processed, and generating a sampling region according to the target mask and the image to be processed;
in response to a first editing request triggered by the user, performing a first editing operation on the sampling region and determining the edited target region as a target image.

13-15. (canceled)

16. The electronic device of claim 12, wherein the in response to a region selection operation triggered by the user for the image to be processed, determining a region to be processed in the image to be processed comprises:
in response to a painting operation triggered by the user on the image to be processed, determining a painting region corresponding to the painting operation, and determining the painting region as the region to be processed;
or,
in response to an object recognition request triggered by the user for the image to be processed, performing a recognition operation on at least one predetermined object in the image to be processed, and in response to a selection operation by the user on the at least one predetermined object, determining a region in which the predetermined object selected by the user is located as the region to be processed;
or,
in response to the region selection operation triggered by the user for the image to be processed, displaying at least one shaped template that is predetermined and determining a target shaped template selected by the user, and in response to a moving operation by the user on the target shaped template, determining a region in which the moved target shaped template is located as the region to be processed.

17. The electronic device of claim 12, wherein the generating a target mask based on the region to be processed comprises:
generating a mask to be processed matching the region to be processed according to the region to be processed, wherein in the mask to be processed, pixel values of the region to be processed are different from pixel values of other regions;
in response to a second editing request triggered by the user for the mask to be processed, performing a second editing operation on the mask to be processed to obtain the target mask;
wherein the second editing operation comprises one or more of a moving operation, a zooming operation, a rotation operation, a flipping operation.

18. The electronic device of claim 12, wherein the generating a sampling region according to the target mask and the image to be processed comprises:
performing a blend operation on the target mask and the image to be processed to obtain the sampling region.

19. The electronic device of claim 12, wherein the in response to a first editing request triggered by the user, performing a first editing operation on the sampling region and determining the edited target region as a target image comprises:
in response to an operation gesture triggered by the user for the sampling region, determining editing content matching the operation gesture, performing the first editing operation on the sampling region according to the editing content, and determining the edited target region as the target image, wherein the editing content comprises one or more of moving editing content, zooming editing content, rotating editing content;
and/or,
in response to a trigger operation by the user on at least one first editing control associated with the sampling region, performing the first editing operation on the sampling region, and determining the edited target region as the target image, wherein the first editing control comprises an editing control for flipping and an editing control for deleting;
and/or,
in response to a trigger operation by the user on at least one second editing control associated with the sampling region, displaying an adjustment control corresponding to the first editing control, in response to an adjustment parameter input by the user by triggering the adjustment control, performing the first editing operation on the sampling region according to the adjustment parameter, and determining the edited target region as the target image, wherein the second editing control comprises an editing control for adjusting a transparency and an editing control for adjusting a feathering degree.

20. The electronic device of claim 12, the acts further comprise:
determining each processing operation triggered by the user for the image to be processed, and determining operation information corresponding to the processing operation, wherein the operation information comprises one or more of a field name, an operation type, an operation specification;
storing in association each processing operation and the operation information corresponding to the processing operation;
the processing operation comprises one or more of a region selection operation, a first editing operation, a second editing operation.

21. The electronic device of claim 20, wherein after the storing in association each processing operation and the operation information corresponding to the processing operation, the acts further comprise:
in response to a backoff request triggered by the user, determining a target processing operation corresponding to the backoff request;
obtaining operation information corresponding to the target processing operation;
performing a re-rendering operation on the image to be processed according to the operation information, so that a processing progress of the image to be processed falls back to the target processing operation.

22. The electronic device of claim 12, wherein after the performing a first editing operation on the sampling region in response to the first editing request triggered by the user, and determining the edited target region as a target image, the acts further comprise:
storing the target image and the target mask to a predetermined storage path.

23. The electronic device of claim 12, wherein after the in response to a first editing request triggered by the user, performing the first editing operation on the sampling region and determining the edited target region as a target image, the acts further comprise:
performing an image restoration operation on the image to be processed according to the target image;
or,
storing the target image.

24. A non-transitory computer-readable storage medium, wherein the computer-readable storage medium stores computer-executable instructions, and the computer-executable instructions, when executed by the processor, implement acts comprising:
in response to a region selection operation triggered by a user for an image to be processed, determining a region to be processed in the image to be processed;
generating a target mask based on the region to be processed, and generating a sampling region according to the target mask and the image to be processed;
in response to a first editing request triggered by the user, performing a first editing operation on the sampling region and determining the edited target region as a target image.
